(19) United States
(12) Patent Application Publication
(10) Pub. No.: US 2026/0357952 A1
(43) Pub. Date: Nov. 12, 2026

(54) DEVICE AND METHOD FOR HEATING A FLOW OF FLUID

(71) Applicant: L'Air Liquide, Societe Anonyme pour l'Etude et l’Exploitation des Procedes Georges Claude, Paris (FR)

(72) Inventor: Golo ZICK, Sassenage (FR)

(21) Appl. No.: 19/153,452

(22) PCT Filed: Jan. 10, 2024
(86) PCT No.: PCT/EP2024/050438

§ 371 Date: Aug. 4, 2025

(30) Foreign Application Priority Data
Feb. 7, 2023 (FR) FR2301128

(51) Int. Cl. F17C 7/04; F17C 9/02

(52) U.S. Cl. CPC F17C 7/04; F17C 9/02; F17C 2223/0161; F17C 2227/0302

(57) ABSTRACT

The invention relates to a device for heating a flow of cryogenic fluid, comprising a set of heat exchanger(s) defining two heat-exchange portions which are arranged in series and each comprise at least one first passage for the flow of cryogenic fluid to be heated and at least one second passage for a heating heat-transfer fluid, the passages being configured to exchange heat, the device comprising a first set of pipes that include a set of valve(s) and are configured to guide the cryogenic fluid into the first passages, and a second set of pipes configured to guide the heat-transfer fluid into the second passages, wherein the first set of pipes and the set of corresponding valve(s) are configured to make it possible to reverse the order of passage of the flow of cryogenic fluid in the two heat-exchange portions arranged in series.

### CROSS REFERENCE TO RELATED APPLICATIONS

This application is a § 371 of International PCT Application PCT/EP2024/050438, filed Jan. 10, 2024, which claims the benefit of FR2301128, filed Feb. 7, 2023, both of which are herein incorporated by reference in their entireties.

### FIELD OF THE INVENTION

The invention concerns a device and a method for heating a flow of fluid, which in particular is cryogenic.

More particularly, the invention concerns a device for heating a flow of cryogenic fluid, for example for the vaporization of liquid hydrogen, comprising a set of heat exchangers, defining, positioned in series, two heat-exchange portions each comprising at least one first passage for the flow of cryogenic fluid to be heated, and at least one second passage for a heating heat-transfer fluid, the first and second passages being configured to exchange thermally, the device comprising a first set of pipes comprising a set of valves, and configured to guide cryogenic fluid in the first passages, and a second set of pipes configured to guide heat-exchange fluid in the second passages.

### BACKGROUND OF THE INVENTION

For reasons of increase of the energy density, the hydrogen is often stored in liquid form, whereas its final use mostly takes place close to ambient temperature, for example in a fuel cell.

It is then indispensable to provide a heating system between the point of collection of liquid and its final use. This heating can take place for example with atmospheric exchanges, but these installations require considerable volume and access to the environment, which is not always possible. In addition, the icing-over of these exchangers (ice) limits the continuous use, and is difficult to evaluate in the design (dimensions).

Other systems use a heating heat-transfer fluid, but it is always subject to the risk of solidification since, apart from helium, all fluids solidify at the boiling temperatures of hydrogen. In this case, two main operating strategies exist, i.e., in a first strategy, this icing-over is provided for in the dimensioning of the heat exchanger. The cross-sections of passages of the heat-transfer fluid side are designed to be sufficiently large to ensure a flow in all conditions. In a second strategy, a dimensioning is carried out wherein the coefficient of heat exchange of the heat-transfer fluid side is far greater than the coefficients of heat exchange of the hydrogen side to be cooled. In addition the thickness which separates the two fluids makes it possible to homogenize the temperatures so that the wall temperature of the heat-transfer fluid side is always above the solidification temperature thereof.

These two strategies have the disadvantage of requiring a substantial volume and above all mass for the exchanger. This can be a major problem in certain applications. In addition, this substantial mass does not make it possible to regulate the temperature of the hydrogen rapidly, as in other types of exchangers, since the thermal inertia of the exchanger itself is a significant brake. These systems often also have a relatively restricted field of operation in terms of flow and pressure.

There is also the possibility of heating the hydrogen at least partly by means of heat produced by electrical resistance, but this is economically and ecologically a solution to be avoided.

### SUMMARY OF THE INVENTION

An objective of the present invention is to eliminate some or all of the disadvantages of the prior art described above.

In an effort to overcome the deficiencies of the prior art discussed, supra, the device according to the invention, which moreover is in conformity with the generic definition thereof provided by the above preamble, is configured such that the first set of pipes and the corresponding set of valves are configured to make it possible to invert the order of passage of the flow of cryogenic fluid in the two heat-exchange portions in series.

In addition, embodiments of the invention can comprise one or more of the following characteristics:
the first set of pipes and the set of valves are configured to make it possible to invert the order of passage of the flow of cryogenic fluid in the two heat-exchange portions in series, by inverting the direction of passage of cryogenic fluid in the first passages, without inverting the direction of circulation of the heating heat-transfer fluid in the second passage;
the flow of cryogenic fluid and the heat-transfer fluid are co-current or counter-current in the one or less of the heat-exchange portions;
the set of valves of the first set of pipes comprises a controlled set of valves configured to invert the order of passage of the flow of cryogenic fluid in the two heat-exchange portions in series, in response to a control signal, for example in response to a value of physical quantity relative to the flow of cryogenic fluid or to the heat-transfer fluid in the device;
the device comprises an electronic data storage and processing unit comprising a microprocessor, and configured to control some or all of the set of controlled valves;
the device comprises at least one sensor for measurement of a value of physical quantity relative to the flow of cryogenic fluid and/or to the heating heat-transfer fluid, for example a temperature, a flow, a state;
the electronic data storage and processing unit is configured to control some or all of the set of controlled valves, according to the value measured by the at least one measurement sensor relative to a reference value;
the two heat-exchange portions positioned in series belong to a single exchanger or to two distinct heat exchangers, for example identical heat exchangers;
the heat exchanger, or at least one of the heat exchangers, is of the type with plates or of the tube(s) type, for example with the second passage positioned around the first passage;
the device comprises a heat exchanger or an additional heat-exchange portion positioned in series downstream from the two heat-exchange portions, and ensuring heat exchange between the cryogenic fluid which has been conveyed in the two heat-exchange portions and a heat-exchange fluid.

The invention also concerns a method for heating a flow of cryogenic fluid, for example liquid hydrogen, using a heating device according to any one of the characteristics above or below, wherein, during a first step, a flow of cryogenic fluid to be heated is circulated in the first passages of the two heat-exchange portions in series in a first order and a first direction of circulation, and, simultaneously, a heating heat-exchange fluid is circulated in the second passages, with the method comprising the step of inversion of a flow of cryogenic fluid to be heated in the first passages of the two heat-exchange portions in series, i.e. in a second order and a second direction of circulation, contrary respectively to the first order and first direction of circulation.

According to other possible particular features:
during the first step, the flows of cryogenic fluid to be heated and of heating heat-exchange fluid circulate in the same direction, i.e. in a co-current manner in the first one of the two heat-exchange portions in series;
during the first step, the flows of cryogenic fluid to be heated and of heating heat-exchange fluid circulate in opposite directions, i.e. in a counter-current manner in the second one of the two heat-exchange portions in series;
the device is configured such that, at the output from the first one of the two heat-exchange portions in series, i.e. between the two heat-exchange portions, the temperature of the cryogenic fluid is maintained higher than the temperature of solidification of the heat-exchange fluid;
the step of inversion is triggered in response to the detection of at least one parameter representative of appearance, or risk of appearance, of solidification of the heat-transfer fluid in a heat-exchange portion;
the at least one parameter representative of appearance comprises at least one from out of: a variation of flow of the heat-transfer fluid, a variation of temperature of the cryogenic fluid and/or of the heat-transfer fluid, a temperature level of the cryogenic fluid and/or of the heat-transfer fluid, a variation of the loss of load within the device.

The invention can also concern any alternative method or device comprising any combination of the characteristics above or below within the context of the claims.

Other particular characteristics and advantages will become apparent from reading the following description, provided with reference to the figures, in which:

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

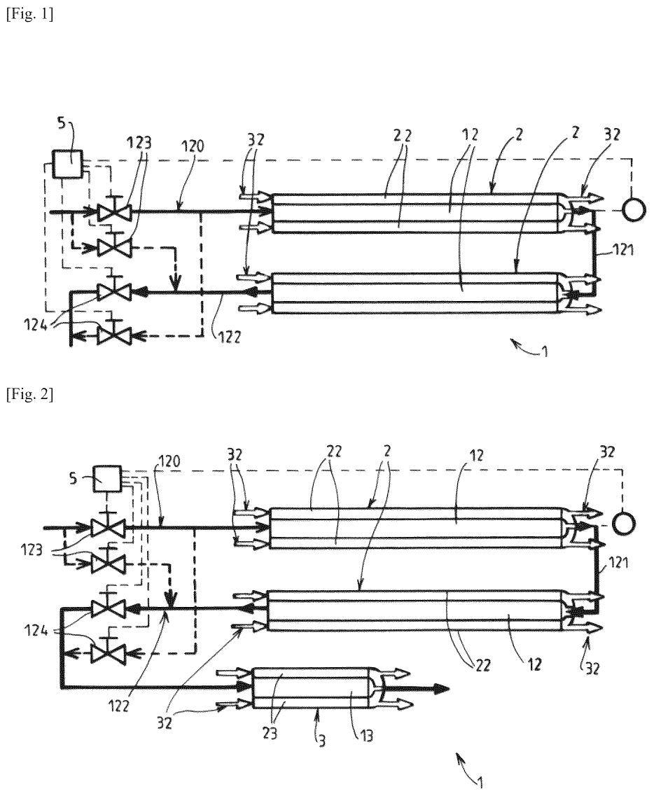

The invention will be better understood by reading the following description provided purely by way of example, with reference to the appended drawings, in which: FIG. 1 is a schematic partial view illustrating an example of the structure and operation of a heating device according to a first embodiment of the invention; FIG. 2 is a schematic partial view illustrating an example of the structure and operation of a heating device according to a second embodiment of the invention.

### DETAILED DESCRIPTION OF THE INVENTION

Throughout the figures, the same references relate to the same elements.

In this detailed description, the following embodiments are examples. Although the description refers to one or more embodiments, this does not mean that the characteristics apply only to a single embodiment. Simple characteristics of different embodiments can also be combined and/or interchanged in order to provide other embodiments.

The device 1 for heating a flow of cryogenic fluid illustrated in FIG. 1 can be used for example for the vaporization or heating of liquid hydrogen. The device 1 can also be used for a non-cryogenic fluid (for example which is liquid at a temperature higher than 150 °C or higher than 100 °C).

More generally, this device 1 can be used for heating of fluid (hydrogen for example) by exchange of heat with a heat-transfer fluid, the temperature of solidification of which is higher than the input temperature of the fluid to be heated.

This device 1 comprises a set of heat exchangers 2, 3 (two heat exchangers positioned in series in this example), defining two heat-exchange portions in series on the path of a flow of fluid, for example cryogenic fluid, to be heated. Each heat-exchange portion comprises at least one first passage 12, 13 for the flow of cryogenic fluid to be heated, and a second passage 22, 23 for a heating heat-exchange fluid, with the first and second passages being in thermal exchange.

The device 1 comprises a first set of pipes 120, 121, 122 comprising a set of valves 123, 124, and being configured to guide cryogenic fluid in the first passages 12, 13. The first set of pipes brings the fluid to the input of the first passage(s) of a first heat-exchange portion, then recuperates the fluid which has circulated there at one output at least of the first heat-exchange portion, and guides the flow to the input of the first passage(s) of the second heat-exchange portion. The circuit recuperates the fluid which has circulated in the second heat-exchange portion at one output at least. This heated cryogenic fluid can then be directed to a downstream application.

The device 1 also comprises a second set of pipes 32 configured to guide heat-transfer fluid in the second passages 22, 23 of the two heat-exchange portions. In the example illustrated, an independent heat-exchange circuit is provided for each heat-exchange portion.

According to a particular characteristic, the first set of pipes 120, 121, 122 and the corresponding set of valves 123, 124 are configured to make it possible to invert the order of passage of the flow of cryogenic fluid in the two heat-exchange portions in series. In other words, the fluid distribution system makes it possible to invert the order of passage of the fluid to be heated in these two heat-exchange portions.

As illustrated in FIG. 1, in a first non-limiting configuration (before inversion), the flow of cryogenic fluid and the heat-transfer fluid are preferably oriented in a co-current manner (same directions) in the first heat exchanger portion, and in a counter-current manner (opposite directions) in the second heat-exchange portion. In this example, each heat-exchange portion has the heat-transfer fluid passing through it in the same direction. In other words, in this example, the two flows of heat-exchange fluid arrive from a single side (which for example is longitudinal) and exit from another single side (which for example is longitudinal).

For example, the first set of pipes 120, 121, 122 and the set of valves 123, 124 make it possible to invert the order of passage of the flow of cryogenic fluid in the two heat-exchange portions in series by inverting the direction of passage of cryogenic fluid in the first passages 12, 13, without inverting the direction of circulation of the heating heat-exchange fluid in the second passages. For this purpose, the ends of the first passages 12 of the two heat-exchange portions situated on a single side can be connected in parallel to an intake of cryogenic fluid to be heated, for example via pipes in parallel and a set of valves 123.

After inversion, the cryogenic fluid and the heat-exchange fluid continue to be co-current in the first heat-exchange portion (the first heat-exchange portion through which the cryogenic fluid passes), then counter-current in the second heat-exchange portion (the second heat-exchange portion through which the cryogenic fluid passes after its passage in the first heat-exchange portion).

Preferably before and after inversion, the second heat-exchange portion again carries out a counter-current heat exchange between the cryogenic fluid and the heat-transfer fluid. Preferably, this heat exchange is again counter-current in the first heat-exchanger portion.

These same ends of the first passages 12 of the two heat-exchange portions which do not open out between the two heat-exchange portions can be connected in parallel to a heated cryogenic fluid output, for example via pipes in parallel and a set of valves 124. In the example illustrated, four two-way valves 123, 124 are used, but it is possible to provide another number of valves, for example by using three-way valves.

With respect to the first configuration of flow symbolized in FIG. 1 with arrows (open valves in white and closed valves in black), the inversion of the path of the flow of cryogenic fluid to be heated can be obtained by inverting the openings/closures of the valves (inverted path in broken lines).

The set of valves 123, 124 of the first set of pipes 120, 121, 122 comprises for example a controlled set of valves configured to invert the order of passage of the flow of cryogenic fluid in the two heat-exchange portions in series in response to a control signal, for example in response to a value of physical quantity relating to the flow of cryogenic or heat-transfer fluid in the device.

The device 1 can comprise an electronic data storage and processing unit 5 comprising a microprocessor, and configured to control some or all of the set of controlled valves.

The device can comprise at least one sensor 4 for measurement of a value of physical quantity relating to the flow of cryogenic fluid and/or the heating heat-transfer fluid, for example a temperature, a flow, a state, in order to trigger (automatically) the inversion of the flow.

For example, the inversion can be triggered in response to the measurement 4 of a low-temperature threshold determined of the cryogenic fluid to be heated measured at the output of the first heat-exchange portion.

Any other alternative or cumulative parameter can be envisaged for generation of the inversion, for example a parameter which is measured or calculated or estimated, representative of the appearance, or risk of appearance, of excessive solidification of heat-transfer fluid in a heat-exchange portion. For example least one of the following parameters (measured or calculated) can trigger the inversion: a variation of flow of the transfer fluid, a variation of temperature of the cryogenic fluid and/or of the heat-transfer fluid, a temperature level of the cryogenic fluid and/or of the heat-transfer fluid, a variation of the loss of load within the device.

Thus, in the case of detection of formation of an excessive layer of solid (for example by imbalance of the flows of the heat-transfer fluid or by decrease of temperature of the fluid to be cooled at the output from the exchanger used in co-current, or by increase of the loss of load of the heat-transfer fluid through the exchanger), the inversion is triggered. The partially heated fluid (temperature higher than the temperature of solidification of the heat-transfer fluid) is put into heat exchange with the solidified portion, which will thus be heated and re-liquefied. This solid will therefore be liquefied rapidly, and the passage cleared once more. This will make it possible if necessary to invert once again the order of the exchangers in the case of detection of a start of blockage in the other passage or portion.

This solution makes it possible to assume temporarily solidification of the heat-transfer fluid for a certain time, before liquefying this solid. The structure of the device does not require the system to be doubled-up entirely in order to ensure this function.

In the example illustrated, the two heat-exchange portions are formed into two distinct heat exchangers (which for example are identical). It will be appreciated that these two heat-exchange portions could be formed within a single heat exchanger.

In addition, the example illustrated comprises concentric tube exchangers (heat-transfer fluid around the fluid to be heated), but other types of heat-exchanger technologies (as well as their combinations) are possible, i.e. heat exchangers of the “tube in tube”, “multi-tube in tube”, “plate” type are possible.

Preferably, the or at least one of the heat exchangers has, for each fluid, a single fluid distributor at the input and a single fluid collector at the output. For example, for the heat-exchange fluid, the distributor (input) and the collector (output) can be common to the two portions. Similarly, it is possible to provide a single calender for the heat-exchange fluid for the two portions, and two or more tubes for the fluid to be heated.

The two heat-exchange portions can have dimensions such that each does not ensure all of the final required heating of the cryogenic fluid. For example each heat-exchange portion is configured to ensure heating of the cryogenic fluid up to a temperature higher than the temperature of solidification of the heat-transfer fluid.

Thus, while the fluid to be heated enters in a co-current manner into the first heat-exchange portion, it is heated to above the temperature of solidification of the heat-transfer fluid. This partially heated fluid then passes into the second heat-exchanger portion, from which it exits at a temperature close to the input temperature of the heat-transfer fluid.

Also preferably, the heat-exchange portions have dimensions such that the coefficient of heat transfer of the heat-transfer fluid side is far higher than the heat-exchange coefficient of the side of the fluid to be cooled.

Preferably, the device is thermally insulated, but preferably without vacuum.

In the case of an installation of this type, the flow of heated fluid can be subjected to variations of temperature, in particular after the passage of the heated fluid into parts of the piping through which very cold fluid has previously passed. In order to smooth or also overheat the fluid, an additional exchanger 3 or portion of heat exchanger can be provided in series downstream as illustrated in FIG. 2 (passages 13, 23, heat-transfer circuit 32 which can be a flow of heat-transfer fluid distinct and different from that used for the aforementioned portions). In other words, a third exchanger (co-current or preferably counter-current) can be provided downstream in order to heat the cryogenic fluid further, or to stabilize its temperature.

The invention permits heating which operates continuously even with variable conditions of operation. The device is light and compact, and can use a conventional heat-transfer fluid.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise. “Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein. “Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. A device for heating a flow of cryogenic fluid, the device comprising:
a set of heat exchangers, defining, positioned in series, two heat-exchange portions each comprising at least one first passage configured for the flow of cryogenic fluid to be heated, and at least one second passage configured for a heating heat-transfer fluid, the first and second passages being configured to exchange thermally;
a first set of pipes comprising a first set of valves, and configured to guide the flow of cryogenic fluid in the first passages, and
a second set of pipes configured to guide the heat-transfer fluid in the second passages,
wherein the first set of pipes and the forst set of valves are configured to make it possible to invert the order of passage of the flow of cryogenic fluid in the two heat-exchange portions in series,
wherein the first set of pipes and the first set of valves are also configured to invert the order of passage of the flow of cryogenic fluid in the two heat-exchange portions in series, by inverting the direction of passage of cryogenic fluid in the first passages, without inverting the direction of circulation of the heating heat-transfer fluid in the second passages.

18. The device as claimed in claim 17, wherein the flow of cryogenic fluid and the heat-transfer fluid are co-current or counter-current in the one or less of the heat-exchange portions.

19. The device as claimed in claim 18, wherein the first set of pipes and its set of valves are configured such that, before and after inversion, the heat transfer fluid and the cryogenic fluid continue to be co-current in the first heat-exchange portion, then counter-current in the second heat-exchange portion.

20. The device as claimed in claim 17, wherein the set of valves of the first set of pipes comprises a set of controlled valves configured to invert the order of passage of the flow of the cryogenic fluid in the two heat-exchange portions in series in response to a control signal.

21. The device as claimed in claim 20, further comprising an electronic data storage and processing unit comprising a microprocessor, and configured to control some or all of the set of controlled valves.

22. The device as claimed in claim 17, further comprising at least one sensor configured to measure a value of physical quantity relative to the flow of cryogenic fluid and/or to the heating heat-transfer fluid.

23. The device as claimed in claim 22, wherein the value of physical quantity is selected from the group consisting of a temperature, a flow, a state, and combinations thereof.

24. The device as claimed in claim 22, wherein the electronic data storage and processing unit is configured to control some or all of the set of controlled valves, according to the value measured by the at least one measurement sensor relative to a reference value.

25. The device as claimed in claim 17, wherein the two heat-exchange portions positioned in series belong to a single exchanger or to two distinct heat exchangers, for example identical heat exchangers.

26. The device as claimed in claim 25, wherein at least one of the heat exchangers is configured such that the second passage is positioned around the first passage.

27. The device as claimed in claim 17, further comprising an additional heat exchanger or an additional heat-exchange portion positioned in series downstream from the two heat-exchange portions, and ensuring heat exchange between the cryogenic fluid which has been conveyed in the two heat-exchange portions and a heat-exchange fluid (32).

28. A method for heating a flow of cryogenic fluid, the method comprising the steps of:
a) providing the device as claimed in claim 17;
b) circulating a flow of cryogenic fluid to be heated in the first passages of the two heat-exchange portions in series in a first order and a first direction of circulation, while also simultaneously circulating a heating heat-exchange fluid in the second passages; and
c) inverting the flow of cryogenic fluid to be heated in the first passages of the two heat-exchange portions in series in a second order and a second direction of circulation that are contrary respectively to the first order and first direction of circulation.

29. The method as claimed in claim 28, wherein, during step b), the flows of cryogenic fluid to be heated and of heating heat-exchange fluid circulate in the same direction in the first one of the two heat-exchange portions in series.

30. The method as claimed in claim 28, wherein, during step b), the flows of cryogenic fluid to be heated and of heating heat-exchange fluid circulate in opposite directions in the second one of the two heat-exchange portions in series.

31. The method as claimed in claim 28, wherein the device is configured such that, at the output from the first one of the two heat-exchange portions in series, a temperature of the cryogenic fluid is maintained higher than a solidification temperature of the heat-exchange fluid.

32. The method as claimed in claim 28, wherein step c) is triggered in response to the detection of at least one parameter representative of appearance, or risk of appearance, of solidification of the heat-transfer fluid in a heat-exchange portion.

33. The method as claimed in claim 32, wherein the at least one parameter representative of appearance comprises at least one from out of: a variation of flow of the heat-transfer fluid, a variation of temperature of the cryogenic fluid and/or of the heat-transfer fluid, a temperature level of the cryogenic fluid and/or of the heat-transfer fluid, a variation of the loss of load within the device.

34. The method as claimed in claim 28, wherein the cryogenic fluid is liquid hydrogen.
